(19) United States
(12) Patent Application Publication
(10) Pub. No.: US 2012/0151150 A1
(43) Pub. Date: Jun. 14, 2012

(54) Cache Line Fetching and Fetch Ahead Control Using Post Modification Information

(75) Inventors: Alexander Rabinovitch, Kfar Yona (IL); Leonid Dubrovin, Karney Shomron (IL)

(73) Assignee: LSI Corporation, Milpitas, CA (US)

(21) Appl. No.: 12/965,136

(22) Filed: Dec. 10, 2010

(51) Int. Cl. G06F 12/08

(52) U.S. Cl. 711/137; 711/E12.057

(57) ABSTRACT

A method is provided for performing cache line fetching and/or cache fetch ahead in a processing system including at least one processor core and at least one data cache operatively coupled with the processor. The method includes the steps of: retrieving post modification information from the processor core and a memory address corresponding thereto; and the processing system performing, as a function of the post modification information and the memory address retrieved from the processor core, cache line fetching and/or cache fetch ahead control in the processing system.

### FIELD OF THE INVENTION

The present invention relates generally to the electrical, electronic, and computer arts, and more particularly relates to improved memory caching techniques.

### BACKGROUND OF THE INVENTION

In computer engineering, a cache is a block of memory used for temporary storage of frequently accessed data so that future requests for that data can be more quickly serviced. As opposed to a buffer, which is managed explicitly by a client, a cache stores data transparently; thus, a client requesting data from a system is not aware that the cache exists. The data that is stored within a cache might be comprised of results of earlier computations or duplicates of original values that are stored elsewhere. If requested data is contained in the cache, often referred to as a cache hit, this request can be served by simply reading the cache, which is comparably faster than accessing the data from main memory. Conversely, if the requested data is not contained in the cache, often referred to as a cache miss, the data is recomputed or fetched from its original storage location, which is comparably slower. Hence, the more requests that can be serviced from the cache, the faster the overall system performance.

In this manner, caches are generally used to improve processor core (core) performance in systems where the data accessed by the core is located in comparatively slow and/or distant memory (e.g., double data rate (DDR) memory). Data cache is used to manage core accesses to the data information. A conventional data cache approach is to fetch a line of data on any data request from the core that results in a cache miss. Typically, the data line is fetched incrementally starting at the lowest address or starting from a specific address requested by the core. Caches that are more sophisticated may implement fetch ahead mechanisms which retrieve to the cache not only the “missed” cache data line, but also the next data line from the memory.

The strategies described above are based on the assumption that the core accesses data in a contiguous manner. However, these assumptions are not always valid for all applications. In such applications where the processor core does not access data in a contiguous manner, standard caching techniques are generally not adequate for improving system performance.

### SUMMARY OF THE INVENTION

Principles of the invention, in illustrative embodiments thereof, advantageously enable a processing core to utilize post modification information to facilitate data cache line fetching and/or cache fetch ahead control in a processing system. In this manner, aspects of the invention beneficially improve processor core performance and reduce overall power consumption in the processor.

In accordance with one embodiment of the invention, a method is provided for performing cache line fetching and/or cache fetch ahead in a processing system including at least one processor core and at least one data cache operatively coupled with the processor core. The method includes the steps of: retrieving post modification information from the processor core and a memory address corresponding thereto; and the processing system performing, as a function of the post modification information and the memory address retrieved from the processor core, cache line fetching and/or cache fetch ahead control in the processing system.

In accordance with another embodiment of the invention, an apparatus for performing cache line fetching and/or cache fetch ahead includes at least one data cache coupled with at least one processor core. The data cache is operative: (i) to retrieve post modification information from the processor core and a memory address corresponding thereto; and (ii) to perform at least one of cache line fetching and cache fetch ahead control as a function of the post modification information and the memory address retrieved from the processor core.

These and other features, objects and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals indicate corresponding elements throughout the several views, and wherein:

FIG. 1 is a block diagram depicting at least a portion of an exemplary data address generation unit of a processing core which can be modified to implement aspects of the present invention, according to an embodiment of the invention;

FIG. 2 is a block diagram depicting at least a portion of an exemplary processing system, according to an embodiment of the present invention;

FIG. 3 is a block diagram depicting at least a portion of an exemplary data cache, according to an embodiment of the present invention;

FIG. 4 is an exemplary method for cache line fetching and/or fetch ahead, according to an embodiment of the present invention; and

FIG. 5 is a block diagram depicting an exemplary system in which aspects of the present invention can be implemented, according to an embodiment of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

Principles of the present invention will be described herein in the context of illustrative embodiments of a methodology and corresponding apparatus for performing data cache line fetching and data cache fetch ahead control as a function of post modification information obtained from a processor core. It is to be appreciated, however, that the invention is not limited to the specific methods and apparatus illustratively shown and described herein. Rather, aspects of the invention are directed broadly to techniques for facilitating access to data in a processor architecture. In this manner, aspects of the invention beneficially improve processor core performance and reduce overall power consumption in the processor.

While illustrative embodiments of the invention will be described herein with reference to specific processor instructions (e.g., using C++, pseudo code, etc.), it is to be appreciated that the invention is not limited to use with these or any particular processor instructions or alternative software. Rather, principles of the invention may be extended to essentially any processor architecture. Moreover, it will become apparent to those skilled in the art given the teachings herein that numerous modifications can be made to the embodiments shown that are within the scope of the present invention. That is, no limitations with respect to the specific embodiments described herein are intended or should be inferred.

A substantial portion of the overall power consumption in a processor can be attributed to memory accesses. This is related, at least in part, to switching activity on data and address buses, as well as to loading of word lines in the memories used by the processor. For at least this reason, among other reasons (e.g., processor code execution efficiency), processor architectures that are able to implement instruction code using a smaller number of data and program memory accesses will generally exhibit better power performance.

Significant power savings can be achieved by providing a storage hierarchy. For example, it is known to employ data caches to improve processor core (i.e., core) performance in systems where data accessed by the core resides in comparatively slow and/or distant memory. A conventional data cache approach is to fetch a line of data on any data request from the core that results in a cache miss. Typically, the data line is fetched incrementally starting at the lowest address or starting from a specific address requested by the core. Caches that are more sophisticated may implement fetch ahead mechanisms which retrieve, to the cache, not only the “missed” cache data line but also the next data line from the memory.

The strategies described above are based on the assumption that the core accesses data in a contiguous manner. However, these assumptions are not always valid for all applications. For example, consider a video application in which data accesses are typically two-dimensional. Furthermore, consider an application involving convolution calculations, wherein two pointers move in opposite directions. In such applications where the core does not access data in a contiguous manner, standard caching methodologies are generally inadequate for improving system performance.

One important issue in a processor architecture is the addressing of values in a stack frame in memory. To accomplish this, a stack or address pointer to the stack frame is typically maintained. In accordance with aspects of the invention, post-modification information (PMI) is used to advantageously control data cache fetching and/or data cache fetch ahead in a processor. In many conventional processor architectures, updating the pointer for the next memory access can require several instructions. In order to reduce the number of instructions required, specialized address generation circuitry may be employed which supports address modifications performed in parallel with normal arithmetic operations. Often, this is implemented using post modification information (PMI). Post modification generally involves generating the next address by adding a modifier, either predefined or determined from a prior operation, to the current address while the current memory access is taking place. In this way, the address pointer can be updated without an instruction cycle penalty.

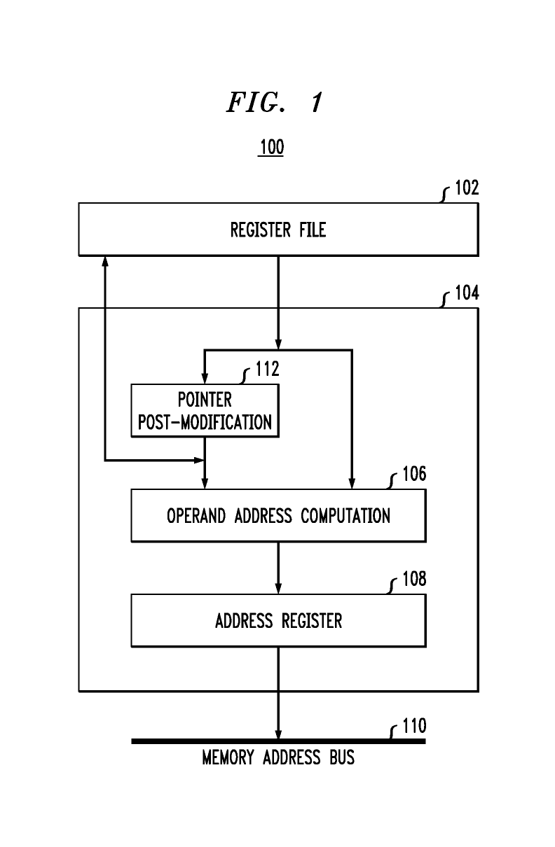

FIG. 1 is a block diagram depicting at least a portion of an exemplary data address generation unit 104 of a core processor 100. Processor 100 further comprises a register file 102 coupled with the data address generation unit 104, the register file preferably including a number of memory mapped registers, such as, for example, address registers, data registers, circular buffer registers, stack pointers, etc., used by the processor, although all registers used by the processor are not limited to memory mapped registers. Data address generation unit 104 is operative to generate an address in an operand address computation circuit 106, for instance by combining a data pointer (e.g., a coefficient data pointer (CDP)) and a data page (DP) register received from register file 102, and placing the generated address in an address register 108, or alternative storage element. Address register 108 may be representative of a plurality of such registers that are associated with various read and write data address buses (e.g., memory address bus 110) to which data address generation unit 104 may be coupled.

The data and/or address pointers utilized by processor 100 may be post modified by a pointer post-modification circuit 112 coupled between register file 102 and operand address computation circuit 106. Post modification of a data pointer can be performed after a completed address is loaded into address register 108. As previously stated, post modification generally involves adding a modifier (e.g., either predefined or calculated from a prior arithmetic operation) to the current address to generate the next address and to prepare the data pointers for the next memory access.

By way of illustration only and without loss of generality, consider the following exemplary “move” instruction: move.b (r0)−, d0. This instruction, when executed by the core, fetches one byte (e.g., 8 bits) from the address in pointer register r0 and moves the fetched byte to data register d0, and then decrements the address in the pointer register r0 by one byte. Similarly, consider the following exemplary “move” instruction: move.b (r0)+n0,d0. This instruction, when executed by the core, fetches one byte from the address in the pointer register r0 and moves the fetched byte to data register d0, and then adds the value of the modification register n0 to the pointer register r0 and stores the result in the pointer register r0.

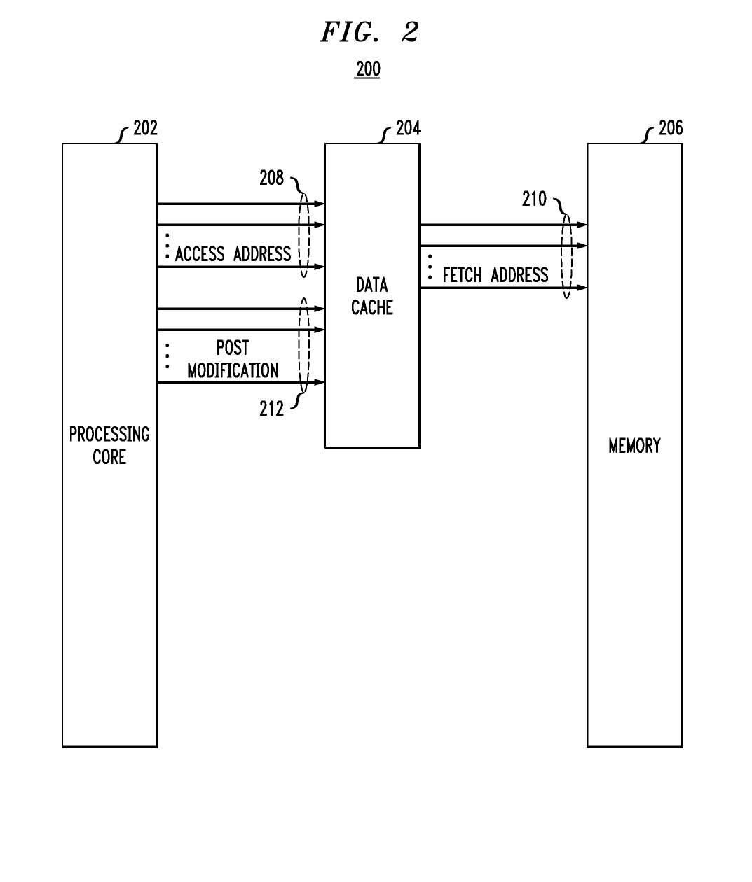

With reference now to FIG. 2, at least a portion of an exemplary processing system 200 is shown, according to an embodiment of the invention. Processing system 200 includes a processing core 202 and a data cache 204 coupled with the processing core. Processing system 200 further includes main memory 206, or an alternative memory which is slower and/or more distant in relation to the processing core 202 than the data cache, operatively coupled with the processing core 202 via the data cache 204. It is to be understood that the processing core 202, data cache 204 and main memory 206 may be collocated within a single integrated circuit chip (e.g., as may be the case with a system-on-a-chip (SoC)) or one or more of the processing core, cache and main memory may be separate from, but communicatively coupled with, the other components. Additionally, the present invention, according to embodiments thereof, is applicable to multi-level cache schemes where the main memory acts as a cache for an additional main memory (e.g., level-1 (L1) cache in static random access memory (SRAM), level-2 (L2) cache in dynamic random access memory (DRAM), and level-3 (L3) cache in a hard disk drive).

Data cache 204 is comprised of memory that is separate from the processing core's main memory 206. Data cache 204 is preferably considerably smaller, but faster in comparison to the main memory 206, although the invention is not limited to any particular size and/or speed of either the data cache or main memory. Data cache 204 essentially contains a duplicate of a subset of certain data stored in main memory 206 which is ideally frequently accessed by the processing core 202.

A cache's associativity determines how many main memory locations map into respective cache memory locations. A cache is said to be fully associative if its architecture allows any main memory location to map into any location in the cache. A cache may also be organized using a set-associative architecture. A set-associative cache architecture is a hybrid between a direct-mapped architecture and a fully-associative architecture, where each address is mapped to a certain set of cache locations. To accomplish this, the cache memory address space is divided into blocks of 2^{m} bytes (the cache line size), discarding the least significant (bottom) m address bits, where m is an integer. An n-way set-associative cache with S sets includes n cache locations in each set, where n is an integer. A given block B is mapped to set {B mod S} (where “mod” represents a modulo operation) and may be stored in any of the n locations in that set with its upper address bits as a tag, or alternative identifier. To determine whether block B is in the cache, set {B mod S} is searched associatively for the tag. A direct-mapped cache may be considered “one-way set associative” (i.e., one location in each set), whereas a fully associative cache may be considered “N-way set associative,” where N is the total number of blocks in the cache.

When the processing core 202 requires certain data, either in performing arithmetic operations, branch control, etc., an address (memory access address) 208 for accessing a desired memory location or locations is sent to data cache 204. If the requested data is contained in data cache 204, referred to as a cache hit, this request is served by simply reading the cache data stored at address 208. Alternatively, when the requested data is not contained in data cache 204, referred to as a cache miss, a fetch address 210, which is indicative of the memory access address 208, is sent to main memory 206 where the data is then fetched into cache 204 from its original storage location in the main memory and also supplied to processing core 202. Data buses used to transfer data between the processing core 202 and the data cache 204, and between the data cache and main memory 206 are not shown in FIG. 2 for clarity purposes, although such bus connections are implied, as will be known by the skilled artisan.

In accordance with aspects of the invention, post modification information (PMI) from the processing core is beneficially used to control cache line fetching and/or cache fetch ahead in the processing core. Specifically, post modification information 212 is retrieved from processing core 202 and sent to data cache 204 along with the corresponding memory access address 208. As apparent from FIG. 2, post modification information 212 is preferably transferred between the processor core 202 and the data cache 204 via a bus that is separate and distinct from a bus used to transfer memory access address information 208 between the core and the cache.

By way of example only and without limitation, consider an exemplary instruction move.b (r0)−, d0 executed by processing core 202, where register r0=0x1000_{—}0025. As previously stated, this instruction, when executed by processing core 202, fetches one byte from the address in pointer register r0 and moves the fetched byte to data register d0, and then decrements the address in the pointer register r0 by one byte. In this illustrative scenario, assume that the memory access address 208 is 0x1000_{—}0025 and the post modification information 212 is −1 (i.e., decrement address 0x1000_{—}0025 by one).

In another illustrative scenario, consider an exemplary instruction move.b (r0)+n0,d0 executed by processing core 202, where register r0=0x1000_{—}0000 and n0=0x100. This instruction, when executed by processing core 202, fetches one byte from the address in the pointer register r0 and moves the fetched byte to data register d0, and then adds the value of the modification register n0 to the pointer register r0 and stores the result in the pointer register r0. In this illustrative scenario, the memory access address 208 is 0x1000_{—}0000 and the post modification information 212 is 0x100.

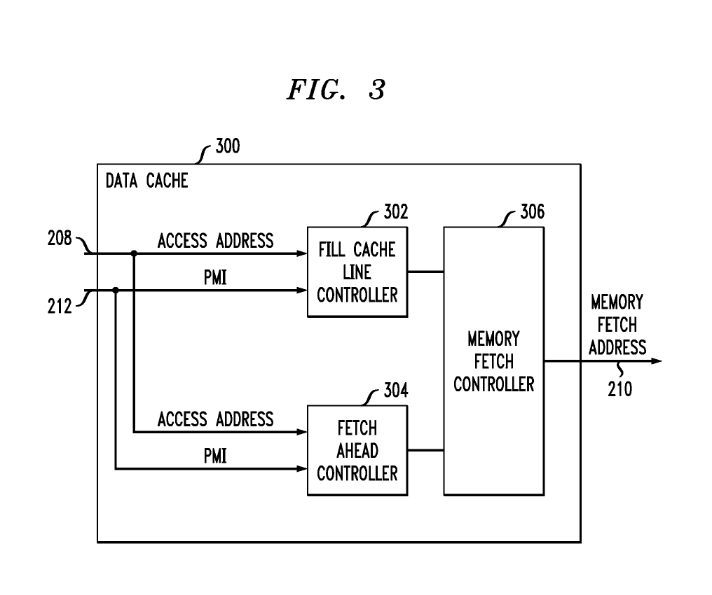

FIG. 3 is a block diagram depicting at least a portion of an exemplary data cache 300, according to an embodiment of the invention. Data cache 300, which may be an implementation of at least a portion of data cache 204 shown in FIG. 2, comprises a fill cache line controller 302 and a fetch ahead controller 304, or alternative control means. Fill cache line controller 302 and fetch ahead controller 304 are coupled with a memory fetch controller 306.

Fill cache line controller 302 is operative to receive a memory access address 208 and corresponding PMI 212 from the processing core (e.g., core 202 in FIG. 2) and to generate a first control signal supplied to memory fetch controller 306. As shown, PMI 212 is preferably transferred between the processing core and the data cache 300 via an additional bus which is separate and distinct from a bus used to convey the memory access address 208. According to other embodiments, PMI 212 may be conveyed using a portion of the same bus used to convey the memory access address. Although not explicitly shown, fill cache line controller 302 preferably includes logic or other control circuitry which is operative to process and compare the PMI 212 with data stored in the data cache 300 (e.g., one or more fields in the respective cache lines). This additional circuitry included in fill cache line controller 302 may be beneficially employed to generate non-sequential data requests to fill one or more cache lines in data cache 300. In this manner, fill cache line controller 302 facilitates data line fetching operations using PMI 212 from the processing core.

Similarly, fetch ahead controller 304 is operative to receive memory access address 208 and corresponding PMI 212 from the processing core and to generate a second control signal supplied to memory fetch controller 306. As previously stated, PMI 212 is preferably transferred between the processing core and the data cache 300 via an additional bus which is separate and distinct from a bus used to convey the memory access address 208. Although not explicitly shown, fetch ahead controller 304 preferably includes logic or other control circuitry which is operative to process and compare the PMI 212 with data stored in the data cache 300 (e.g., one or more fields in the respective cache lines). This additional circuitry included in fetch ahead controller 304 may be beneficially employed to generate non-sequential line requests to fill one or more cache lines in data cache 300. In this manner, fetch ahead controller 304 facilitates data fetch ahead operations using PMI 212 from the processing core.

Memory fetch controller 306 is operative to generate a memory fetch address 210 for retrieving requested data corresponding to the memory access address 208 from main or other slower memory (e.g., memory 206 in FIG. 2) as a function of the first and second control signals, depending on whether the data cache 300 is used in a cache fill mode (e.g., by assertion of the first control signal from fill cache line controller 302) or in a fetch ahead mode (e.g., by assertion of the second control signal from fetch ahead controller 304). Although depicted as separate functional units, it is to be appreciated that at least a portion of one or more of the fill cache line controller 302, fetch ahead controller 304 and memory fetch controller 306 may be integrated together within the same block, either alone or with other functional blocks (e.g., circuitry, software modules, etc.), with the respective functions thereof being incorporated into the combined block.

In terms of operation of data cache 300, in the scenario that the PMI is used to reference the same data cache line, such as, for example, by modifying a pointer to point to the same cache line, an assumption is preferably that the next core access will be made to the same data cache line and that data fetched to the cache line should be prioritized according to the PMI. More particularly, a cache line is usually longer than a single access from core to cache, and from cache to main (or slower) memory. Therefore, on the next core access, the core will access the same cache line. Thus, it may not be necessary to fetch another cache line, but rather fetch the missed cache line in a different order. By way of example only, consider an illustrative instruction move.b (r0)−, d0 executed by the processing core (e.g., core 202 in FIG. 2), where register r0=0x1000_{—}0025. In this illustrative scenario, the memory access address 208 is 0x1000_{—}0025 and the PMI 212 is −1 (i.e., decrement address 0x1000_{—}0025 by one). Fetches to main memory for filling the data cache line are preferably made in the following order:

0x1000_{—}0025

0x1000_{—}0024

0x1000_{—}0023

0x1000_{—}0022

. . . ,

thus bringing data to the cache in the order it will most likely be used. In the example above, the fetched order is opposite to the default incremental order. When the fetch ahead mode of data cache 300 is used, the next cache line predicted by the PMI direction is preferably fetched.

In the scenario that the PMI is used to reference a different data cache line, such as, for example, by modifying the pointer to point to a cache line other than the current cache line, an assumption is preferably that the next core access will be made to a different data cache line and that this data cache line should be pre-fetched according to the PMI when the data corresponding to the newly referenced cache line is not already stored in the cache. When the data corresponding to the different cache line already resides in the cache (and thus prefetching is not required), a cache replacement policy (e.g., least recently used (LRU), etc.) characteristic associated with the different cache line may be modified (or otherwise updated) so that the data corresponding to the different cache line is retained.

By way of example only, consider an illustrative instruction move.b (r0)+n0,d0 executed by the processing core 202 (FIG. 2), where register r0=0x1000_{—}0000 and n0=0x100. In this illustrative scenario, the memory access address 208 is 0x1000_{—}0000 and the PMI 212 is 0x100. Fetches to main memory for filling the data cache line are preferably made in the following order:

| | |
|---|---|
| 0x1000_0000 | bring the data to the critical word; |
| . . . | bring the data to fill part or whole data cache line. |
| | (The data cache controller may also decide not to bring |
| | data located in the locations that are not predicted by the |
| | PMI.) |
| 0x1000_0100 | fetch ahead to fill the data cache line that is most likely be |
| | used next. |

As previously stated, when the post modified pointer points to a memory address that is already in the cache, no fetch ahead is required. The cache replacement policy (e.g., LRU) status of that cache line is preferably changed to prevent discarding of the data in that cache line.

By utilizing post modification information for controlling data cache line fetching and/or data cache fetch ahead according to techniques of the invention, a processor core is more easily able to predict where to access data for subsequent operations, etc., without regard for the manner in which data is accessed and without the need for additional instruction cycles and/or processing complexity.

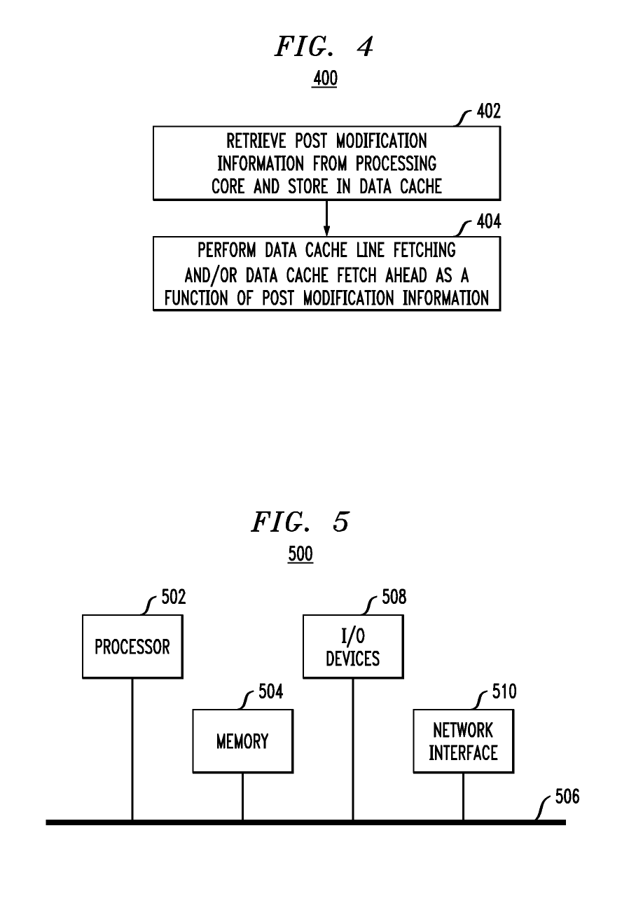

With reference now to FIG. 4, at least a portion of an exemplary methodology 400 for facilitating cache line fetching and/or fetch ahead control in a processor is shown, according to an embodiment of the invention. Method 400, in step 402, preferably retrieves post modification information (e.g., PMI 212 in FIG. 2) from a processor core (e.g., processing core 202 in FIG. 2) and stores, or otherwise transfers, the post modification information to the data cache (e.g., data cache 204 in FIG. 2). As previously described, the post modification information may be transferred from the processor core to data cache along with a corresponding memory access address (e.g., access address 208 in FIG. 2). In step 404, data cache line fetching and/or fetch ahead control, depending on whether the data cache 300 is used in a cache fill mode (e.g., by assertion of the first control signal from the fill cache line controller 302) or in a fetch ahead mode (e.g., by assertion of the second control signal from the fetch ahead controller 304), is performed as a function of the post modification information stored in the data cache.

Methodologies of embodiments of the present invention may be particularly well-suited for implementation in an electronic device or alternative system, such as, for example, a microprocessor or other processing device/system. By way of illustration only, FIG. 5 is a block diagram depicting an exemplary data processing system 500, formed in accordance with an aspect of the invention. System 500 may represent, for example, a general purpose computer or other computing device or systems of computing devices. System 500 may include a processor 502, memory 504 coupled with the processor, as well as input/output (I/O) circuitry 508 operative to interface with the processor. The processor 502, memory 504, and I/O circuitry 508 can be interconnected, for example, via a bus 506, or alternative connection means, as part of data processing system 500. Suitable interconnections, for example via the bus, can also be provided to a network interface 510, such as a network interface card (NIC), which can be provided to interface with a computer or Internet Protocol (IP) network, and to a media interface, such as a diskette or CD-ROM drive, which can be provided to interface with media. The processor 502 may be configured to perform at least a portion of the methodologies of the present invention described herein above.

It is to be appreciated that the term “processor” as used herein is intended to include any processing device, such as, for example, one that includes one or more processor cores, a central processing unit (CPU) and/or other processing circuitry (e.g., network processor, DSP, microprocessor, etc.). Additionally, it is to be understood that the term “processor” may refer to more than one processing device, and that various elements associated with a processing device may be shared by other processing devices. The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, one or more output devices (e.g., printer, monitor, etc.) for presenting the results associated with the processor, and/or interface circuitry for operatively coupling the input or output device(s) to the processor.

Accordingly, an application program, or software components thereof, including instructions or code for performing the methodologies of the invention, as described herein, may be stored in one or more of the associated storage media (e.g., ROM, fixed or removable storage) and, when ready to be utilized, loaded in whole or in part (e.g., into RAM) and executed by the processor 502. In any case, it is to be appreciated that at least a portion of the components shown in any of FIGS. 1 through 4 may be implemented in various forms of hardware, software, or combinations thereof, e.g., one or more DSPs with associated memory, application-specific integrated circuit(s), functional circuitry, one or more operatively programmed general purpose digital computers with associated memory, etc. Given the teachings of the invention provided herein, one of ordinary skill in the art will be able to contemplate other implementations of the components of the invention.

At least a portion of the techniques of the present invention may be implemented in one or more integrated circuits. In forming integrated circuits, die are typically fabricated in a repeated pattern on a surface of a semiconductor wafer. Each of the die includes a memory described herein, and may include other structures or circuits. Individual die are cut or diced from the wafer, then packaged as integrated circuits. One skilled in the art would know how to dice wafers and package die to produce integrated circuits. Integrated circuits so manufactured are considered part of this invention.

An IC in accordance with embodiments of the present invention can be employed in any application and/or electronic system which is adapted for performing multiple-operand logical calculations in a single instruction. Suitable systems for implementing embodiments of the invention may include, but are not limited to, personal computers, portable computing devices (e.g., personal digital assistants (PDAs)), multimedia processing devices, etc. Systems incorporating such integrated circuits are considered part of this invention. Given the teachings of the invention provided herein, one of ordinary skill in the art will be able to contemplate other implementations and applications of the techniques of the invention.

Although illustrative embodiments of the present invention have been described herein with reference to the accompanying drawings, it is to be understood that the invention is not limited to those precise embodiments, and that various other changes and modifications may be made therein by one skilled in the art without departing from the scope of the appended claims.

What is claimed is:

1. A method for performing at least one of cache line fetching and cache fetch ahead in a processing system including at least one processor core and at least one data cache operatively coupled with the processor core, the method comprising the steps of:
retrieving post modification information from the processor core and a memory address corresponding thereto; and
the processing system performing at least one of cache line fetching and cache fetch ahead control in the processing system as a function of the post modification information and the memory address retrieved from the processor core.

2. The method of claim 1, further comprising:
determining whether the post modification information references a same cache line;
when the post modification information references the same cache line, configuring the processor core to next access the same cache line; and
prioritizing an order of data fetched to the cache as a function of the post modification information.

3. The method of claim 2, wherein the step of determining whether the post modification information references a same cache line comprises determining whether the post modification information modifies a pointer to address the same data cache line.

4. The method of claim 1, further comprising:
determining whether the post modification information references a different cache line;
when the post modification information references a different cache line, configuring the processor core to next access the different cache line; and
pre-fetching the different cache line as a function of the post modification information when data corresponding to the different cache line is not stored in the data cache.

5. The method of claim 4, further comprising changing a cache replacement policy characteristic associated with the different cache line when data corresponding to the different cache line is already stored in the data cache so that the data corresponding to the different cache line is retained.

6. The method of claim 4, wherein the step of determining whether the post modification information references a different cache line comprises determining whether the post modification information modifies a pointer to address another cache line which is different than a current cache line.

7. The method of claim 1, further comprising transferring the post modification information between the processor core and the data cache via a connection that is separate and distinct from a connection used to transfer the memory address between the processor core and the data cache.

8. The method of claim 1, further comprising storing in the data cache the post modification information retrieved from the processor core, wherein the step of performing at least one of cache line fetching and cache fetch ahead control is performed as a function of the post modification information stored in the data cache.

9. The method of claim 1, further comprising updating a status of a cache replacement policy in the data cache as a function of the post modification information retrieved from the processor.

10. The method of claim 1, further comprising generating one or more non-sequential data requests to fill one or more cache lines in the data cache as a function of the post modification information retrieved from the processor.

11. The method of claim 1, further comprising generating one or more non-sequential cache line requests to fill one or more cache lines in the data cache as a function of the post modification information retrieved from the processor.

12. An apparatus for performing at least one of cache line fetching and cache fetch ahead, the apparatus comprising:
at least one data cache coupled with at least one processor core, the data cache being operative: (i) to retrieve post modification information from the processor core and a memory address corresponding thereto; and (ii) to perform at least one of cache line fetching and cache fetch ahead control as a function of the post modification information and the memory address retrieved from the processor core.

13. The apparatus of claim 12, wherein the at least one data cache is operative:
to determine whether the post modification information references a same cache line;
to configure the processor core to next access the same cache line when the post modification information references the same cache line; and
to prioritize an order of data fetched to the cache as a function of the post modification information.

14. The apparatus of claim 13, wherein the at least one data cache is operative to determine whether the post modification information references the same cache line by determining whether the post modification information modifies a pointer to address the same data cache line.

15. The apparatus of claim 12, wherein the at least one data cache is operative:
to determine whether the post modification information references a different cache line;
to configure the processor core to next access the different cache line when the post modification information references a different cache line; and
to pre-fetch the different cache line as a function of the post modification information when data corresponding to the different cache line is not stored in the data cache.

16. The apparatus of claim 15, wherein the at least one processor core is further operative to change a cache replacement policy characteristic associated with the different cache line when data corresponding to the different cache line is already stored in the data cache so that the data corresponding to the different cache line is retained.

17. The apparatus of claim 15, wherein the at least one data cache is operative to determine whether the post modification information references a different cache line by determining whether the post modification information modifies a pointer to address another cache line which is different than a current cache line.

18. The apparatus of claim 12, further comprising:
a first connection coupled between the at least one processor core and the at least one data cache, the first connection being operative to transfer the post modification information between the processor core and the data cache; and
a second connection coupled between the at least one processor core and the at least one data cache, the second connection being operative to transfer the memory address between the processor core and the data cache, the first connection being separate and distinct from the second connection.

19. The apparatus of claim 12, wherein the at least one data cache comprises at least one controller operative, as a function of the post modification information retrieved from the processor core, to generate:
(i) at least one of one or more non-sequential cache line requests and
(ii) one or more non-sequential data requests for filling one or more cache lines in the data cache.

20. The apparatus of claim 12, wherein the at least one data cache comprises comparison circuitry operative to compare the post modification information with data stored in the data cache.

21. The apparatus of claim 12, wherein the at least one data cache comprises:
a first controller operative to receive a memory access address and corresponding post modification information from the at least one processor core and to compare the post modification information with data stored in the data cache, the first controller generating a first control signal as a function of a comparison of the post modification information with data stored in the data cache;
a second controller operative to receive the memory access address and corresponding post modification information from the at least one processor core and to compare the post modification information with data stored in the data cache, the second controller generating a second control signal as a function of a comparison of the post modification information with data stored in the data cache; and
a third controller operative to receive the first and second control signals and to generate a memory fetch address for retrieving, from memory external to the data cache, requested data corresponding to the memory access address as a function of the first and second control signals, depending on whether the at least one data cache is operative in a cache fill mode or in a fetch ahead mode.

22. The apparatus of claim 12, further comprising the at least one processor core.

23. An electronic system, comprising:
at least one integrated circuit, the at least one integrated circuit comprising:
at least one data cache coupled with at least one processor core, the data cache being operative: (i) to retrieve post modification information from the processor core and a memory address corresponding thereto; and (ii) to perform at least one of cache line fetching and cache fetch ahead control as a function of the post modification information and the memory address retrieved from the processor core.
